(19) United States
(12) Patent Application Publication
(10) Pub. No.: US 2003/0223803 A1
(43) Pub. Date: Dec. 4, 2003

(54) Writing pen with piezo sensor

(76) Inventor: Stefaan De Schrijver, Newton, MA (US)

Correspondence Address: LAHIVE & COCKFIELD, 28 STATE STREET, BOSTON, MA, 02109, US

(21) Appl. No.: 10/317,015

(22) Filed: Dec. 11, 2002

Related U.S. Application Data
(63) Continuation of application No. PCT/US01/40991, filed on Jun. 14, 2001.
(60) Provisional application No. 60/212,322, filed on Jun. 16, 2000.

(51) Int. Cl. B43K 29/00

(52) U.S. Cl. 401/195

(57) ABSTRACT

An apparatus structured as a writing instrument and providing the functionality of a writing instrument such as a pen, with additional functionality including that of a joystick, a mouse, a stylus, or a keyboard. One embodiment of the writing instrument structure includes piezoelectric sensors for measuring force of the writing instrument against a surface in three directions, acceleration of the writing instrument in three directions, tilt of the writing instrument two directions, magnetic field surrounding the writing instrument in two directions, and energy dissipation during a motion or sequence of motions. The various measurements can allow for reconstruction of the writing instrument motion, thereby allowing control of other devices. The biometric data can be combined with other data to provide inputs to a biometric authentication system including a signature verification system.

### RELATED INFORMATION

The present application is a continuation of PCT patent application number PCT/US01/40991, filed on Jun. 14, 2001, which claims priority to U.S. provisional patent application No. 60/212,322, filed on Jun. 16, 2000, the entire contents both of which are hereby incorporated by reference.

### BACKGROUND OF THE INVENTION

(1) Field of the Invention

The present invention relates generally to peripheral devices, and more specifically to incorporating computer input/output functionality into a single device.

(2) Description of the Prior Art

As electronic component manufacturing evolves to allow smaller electronic component fabrication at reduced cost, the demand increases for embedding smart electronics into multiple appliances, possibly networked. This may be the case with factory platforms, warehousing environments, automotive vehicles, medical instruments, consumer household appliances, even medical implants. The increased desire for smaller consumer electronics, coupled with the increased use and functionality of personal computers, exposes the limitation in miniaturization in the personal computer market: the peripheral devices. Traditional peripheral devices include but are not limited to, a keyboard, mouse, and joystick. Some products have eliminated the keyboard and mouse requirement with a stylus; however, the stylus is not universally accepted by a wide range of products, and the stylus functionality is limited. The stylus can require interaction with a compatible input device, typically a touch screen and associated operating system, for proper operation. Additionally, the stylus cannot perform functions equivalent to that of a joystick, as most stylus-compatible products do not allow for such functionality. Most styluses are used with a computerized platform such as a pen computer, or Personal Digital Assistant that act as a receiver and as a display nit to the stylus.

There is currently not an easily integrated peripheral device that performs universal functions typically provided by computer peripherals including a computer mouse, keyboard, joystick, and display.

What is needed is a single device that incorporates the functionality of a computer mouse, keyboard, joystick, and stylus, without dependency on a particular operating system and that can address multiple appliances that contain embedded smart electronics.

### SUMMARY OF THE INVENTION

The present invention is an apparatus that provides the peripheral functions heretofore traditionally provided by a computer mouse, keyboard, joystick, and stylus and display. The apparatus can be the form of a writing instrument such as a pen, pencil, or stylus. The writing instrument structure can be instrumented with piezoelectric sensors to measure force, tilt, magnetic field, and acceleration. The compilation of measurements can allow reconstruction of the writing instrument positions and motions. The apparatus of the present invention is powered by electromagnetic induction, thus eliminating the need for batteries. The methods of the present invention allow the usage of the apparatus to write on any surface. The orientation of the surface is not necessarily horizontal: it can be vertical or inclined. The surface does not have to be planar.

Other objects and advantages of the present invention will become more obvious hereinafter in the specification and drawings.

### BRIEF DESCRIPTION OF THE DRAWINGS

A more complete understanding of the invention and many of the attendant advantages thereto will be readily appreciated as the same becomes better understood by reference to the following detailed description when considered in conjunction with the accompanying drawings, wherein like reference numerals refer to like parts and wherein:

FIG. 1 presents a gradient of the earth magnetic fields relative to the earth gravitational field as measured by a magnetic sensor;

FIG. 2 presents a flow chart of a method for handling the apparatus of the invention

FIG. 3 illustrates an example system architecture for implementing the invention.

### DESCRIPTION OF THE ILLUSTRATED EMBODIMENTS

To provide an overall understanding of the invention, certain illustrative embodiments will now be described; however, it will be understood by one of ordinary skill in the art that the systems described herein can be adapted and modified to provide systems for other suitable applications and that other additions and modifications can be made to the invention without departing from the scope hereof.

In an embodiment, the combination of force, angle, tilt, acceleration, and magnetic field can allow for reconstruction of the writing instrument motion. Such reconstruction provides a basis for signature verification systems, for example. Additionally, if the writing instrument movement can be reconstructed, commands written by the writing instrument can be recorded and interpreted to control other devices, much like commands entered by a keyboard. Such movement reconstruction can allow the writing instrument to replace the functionality traditionally viewed as reserved for keyboards, a computer mouse, a joystick, or a stylus. For example, characters of a command can be interpreted and used to enter a command to a computer or other system in the same manner as entered by a keyboard interfaced to the computer or system. The interpreted command can cause the computer, or similar device, to execute an instruction set in much the same manner as a keyboard entry, stylus command, joystick movement, etc., wherein an instruction set can be understood to be at least one instruction that can be submitted to a microprocessor.

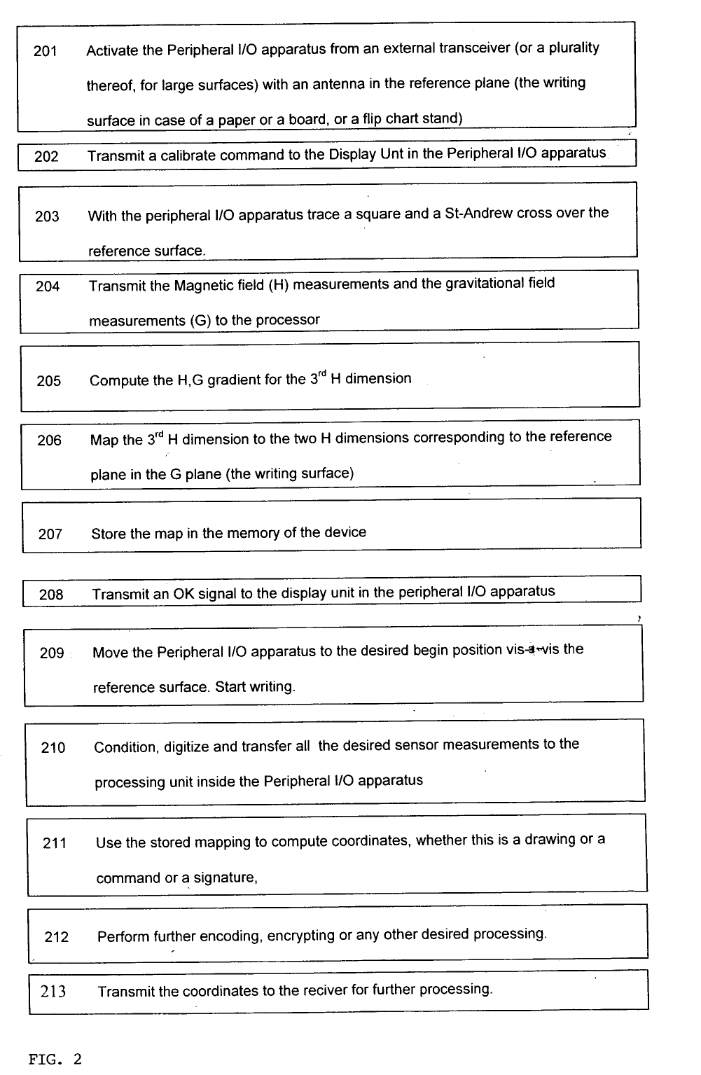

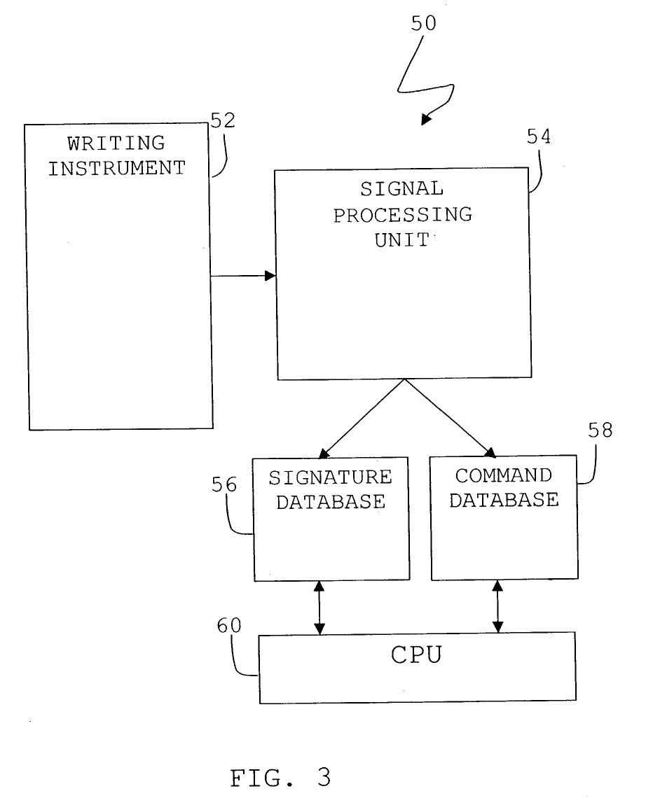

The peripheral I/O apparatus with sample system architecture in FIG. 3, can reconstruct writing because of the methods and processes of the present invention. These methods are illustrated in FIG. 2. The entire system includes an antenna set-up that also functions as power inducer, as is known in the art.

The method described in FIG. 2 which uses this gradient is as follows. A planar antenna in the appliance determines the position and orientation of the writing surface in space. This orientation is unknown to the peripheral I/O apparatus of the present invention, and it may vary over time. Furthermore, in order to reconstruct written input, be it for command recognition, signature, or handwriting, the absolute position of the writing must be known relative to the writing surface. For example, does the writing start in the upper left-hand comer or in the center of the “page”? If the writing is interrupted, where does it resume? Currently tablets or touch screens are used to determine the planar X, Y coordinates of writing. It is impossible to write on curved surfaces because they were not planar. Similarly, if the surfaces are large such as for white boards, that becomes an expensive set-up.

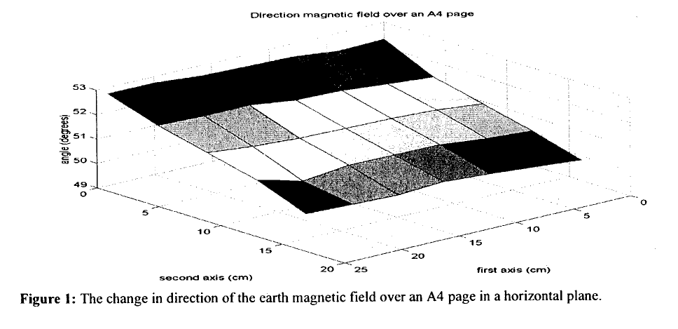

It is an object of the present invention to provide a method that allows the determination of absolute XY coordinates, without the help of tablets or touch screens. The method is based on the determination of the gradient of the magnetic field over a writing surface with regards to the horizontal plane in the gravitational field. On a local basis, the gravitational field has always the direction (towards the center of the earth) and the same magnitude g. Since writing is a local occupation, the gravitational field is always constant with regards to the extension of the writing surface. Even if one travels from one elongation and altitude to another elongation and altitude, locally the gravitational field remains constant. However the earth magnetic field, even in the absence of metal objects that may cause disturbances, has three variable components. If measured over the surface of a page of A4 format, the earth magnetic field shows a gradient with regards to XY plane in the earth gravitational field. This feature can be used to help calibrate electronic compasses. However, as shown in FIG. 1, the gradient of the magnetic field H also can be used to determine an XY coordinate system over a horizontal plane in the earth gravitational field G. The same holds true for a YZ coordinate system over a vertical plane. In either case Y is the perceived direction of the earth magnetic north pole.

Thus measurements of the earth magnetic field in three dimensions in combination with measurements of the earth gravitational field with a three dimension accelerator setup yields an absolute coordinate system over a local extension The antenna transmits a variable electromagnetic field in the RF domain. A properly designed coiling antenna in the peripheral I/O apparatus converts the alternating fields into an electric current, as known in the art. This current produces enough power to power the electronics inside the peripheral I/O apparatus. Thus, the sensors can measure the analog signals, operational amplifiers can condition the signals, Analog to Digital converters can digitize them, the processors can encode and/or encrypt them, the memory can store them, and RF circuitry can transmit them to the transceivers connected to the original antenna.

Conversely signals can be sent to the peripheral I/O apparatus for the purpose of displaying information on a display, or for processing information, or for actuating actuators in the peripheral I/O device. Thus the peripheral I/O device can control and manage an electronic appliance, a medical instrument, or an automotive component.

Considering the low power requirements, highly integrated electronic circuitry is desirable. Piezo sensors are preferred over resistive sensors wherever possible. The peripheral I/O device must provide the necessary mechanical and electronic grounding to that extent it may contain support components that fulfill these subjective functions.

Software provides functional management, at some level embedded in the peripheral I/O apparatus, and at some level at the control and command center to which the apparatus is a peripheral.

Referring to FIG. 2 the process 200 for control and command of the peripheral Input/Output device is as shown in FIG. 2, which is a schematic of the method.

Referring now to FIG. 3, there is shown a sample system architecture 50 for practicing the invention, although those with ordinary skill in the art will recognize that the FIG. 3 system is provided merely for illustration and not limitation. The writing instrument 52, as described herein, measures force, angles, accelerations, magnetic field, and tilt, and can communicate the respective measurements to a signal processing unit 54 that receives the signals and processes them, for example, by filtering and amplifying. Other signal processing techniques can also be utilized without departing from the scope of the invention. The communications between the writing instrument 52 and signal processor 54 can be wired or wireless, RF, infrared, ultrasound, etc., using well-known communications techniques and protocols, without departing from the invention. The signal processor 54 can additionally process the signals to reconstruct the writing instrument motion. In such an embodiment, processed writing instrument motion results can be communicated to a command database 58 from which a command can be retrieved and subsequently submitted to a microprocessor 60 for processing. Alternatively, the signal processor 54 can generate a handwriting sample or related statistic for comparison to a signature database 56, wherein the microprocessor 60 can compare the database information to the signal processing unit data to verify a handwriting sample. The FIG. 3 system 50 is merely a sample intended to present illustrations of the invention and attendant system architectures. Those skilled in the art will recognize that many other embodiments exist without departing from the scope of the invention.

Although the present invention has been described relative to a specific embodiment thereof, it is not so limited. Obviously many modifications and variations of the present invention may become apparent in light of the above teachings. For example, although three sets of rods were presented to measure forces in the x, y, and z Cartesian coordinate system, only one or two of such directions may be desired. Similarly, one or more of the other sensors may be eliminated while remaining within the scope of the invention. The writing instrument structure and composition materials may be altered. The methods of measuring particular parameters may be changed without departing from the scope herein.

An advantage of the invention over the prior art is that the invention provides a single device that may replace the functionality typically associated with a keyboard, mouse, joystick or stylus.

Many additional changes in the details, materials, steps and arrangement of parts, herein described and illustrated to explain the nature of the invention, may be made by those skilled in the art within the principle and scope of the invention. Accordingly, it will be understood that the invention is not to be limited to the embodiments disclosed herein, may be practiced otherwise than specifically described, and is to be understood from the following claims, that are to be interpreted as broadly as allowed under the law.

What is claimed is:

1. A writing instrument, comprising at least one magnetic field sensor.

2. A writing instrument according to claim 1, further comprising:
a first magnetic field sensor pair; and,
a second magnetic field sensor pair, the distinct second magnetic field sensor pair configured orthogonally to the first magnetic field sensor pair.

3. A writing instrument according to claim 2, wherein the first and distinct second magnetic field sensor pairs further comprise a wheatstone bridge.

4. A writing instrument according to claim 1, further comprising at least one sensor to measure force of the writing instrument against a writing surface.

5. A writing instrument according to claim 2, further comprising:
at least one first force sensor to measure force in a first direction; and,
at least one distinct second force sensor to measure force in a distinct second direction, wherein the second direction is orthogonal to the first direction.

6. A writing instrument according to claim 5, further comprising at least one third force sensor to measure force in a third direction, wherein the third direction is orthogonal to the first direction and the second direction.

7. A writing instrument according to claim 1, further comprising at least one tilt sensor to measure tilt of the writing instrument.

8. A writing instrument according to claim 1, further comprising at least one acceleration sensor.

9. A writing instrument according to claim 4, wherein the force sensor includes a piezoelectric device.

10. A writing instrument, comprising at least one tilt sensor to measure a gravitational force.

11. A writing instrument according to claim 10, further comprising at least one angle sensor.

12. A method of generating an instruction set from the motion of a writing instrument, comprising,
tracking the writing instrument motion using at least one magnetic field sensor; and,
associating the tracked motion to a selected instruction set.

13. A method according to claim 12, wherein the selected instruction set includes at least one instruction.

14. A method according to claim 12, wherein tracking the writing instrument includes sensing at least one of a writing instrument force, writing instrument angle, and writing instrument tilt.

15. A method according to claim 12, associating the tracked motion further includes reconstructing the tracked motion.

16. A method according to claim 15, further comprising determining characters from the reconstructed motion.
